(19) United States
(12) Patent Application Publication
(10) Pub. No.: US 2007/0052246 A1
(43) Pub. Date: Mar. 8, 2007

(54) Locking device and a method of assembling same

(76) Inventor: Torbjön Blomqvist, Lammhult (SE)

Correspondence Address: DAVIS & BUJOLD, P.L.L.C., 112 PLEASANT STREET, CONCORD, NH, 03301, US

(21) Appl. No.: 10/570,086

(22) PCT Filed: Jun. 18, 2004
(86) PCT No.: PCT/SE04/00982

§ 371 Date: Mar. 1, 2006

(30) Foreign Application Priority Data
Sep. 5, 2003 (SE) 0302392-6

(51) Int. Cl. E05C 9/12

(52) U.S. Cl. 292/39

(57) ABSTRACT

The invention relates to a locking device at a spagnolet mechanism (1), anchored in a door or window case (39), which mechanism comprises a central adjusting mechanism (2), from which locking rods (7) originate in mutually opposite directions, the free ends of the locking rods (7) being anchored in recesses (41) in a frame (40), a locking bolt (42) being responsible for the locking, which is pivotable around a stationary revolving spindle pin (44) by the locking rods, which locking bolt (42) via a connection link (43) with joints adjacent its ends in a locking house (16) is connected to the associated locking rod. According to the invention the locking bolt (42) is partially inserted into the locking house (16) and is anchored there by way of the revolving spindle pin (44). The locking bolt is connected in an extreme outwardly pivoted position to the connection link (43) via its first joint (45) and is pivoted into the locking house jointly with connection link, which in the locking house is connected to its second joint (46) with the corresponding locking rod end, which jointly with the adjusting mechanism (2) prevent the locking bolt (42) from pivoting back to the extreme position. In this way the unity of the coupling is secured.

This application is a national stage completion of PCT/SE2004/000982 filed Jun. 18, 2004 which claims priority from Swedish Application Serial No. 0302392-6 filed Sep. 5, 2003.

### FIELD OF THE INVENTION

The present invention relates to a locking device and is described in detail in the preamble of claim 1. The invention relates also to a method of assembling such a locking device according to the preamble of the first process claim.

### BACKGROUND OF THE INVENTION

Such locking devices are used in spagnolets, the central adjusting mechanism of which e.g. can correspond to the one shown and described in EP 0 932 739.

The locking rods, which mesh with the frame, have so far often been made in a simple way, i.e. with a straight locking rod end, provided with a covering and meshing in a locking position with a recess in the frame, possibly with a protective plate. However, this locking method has several drawbacks. It is e.g. not very difficult to pry the case and the frame from each other by means of burglary tools within the area of the lock rods and brake open all this unit. The locking rods are straight and offer not much resistance. Also, it is from a construction point of view not very suitable to press very long and/or strong locking rod sections into said recesses. Another drawback is, that the spagnolet mechanisms often are made in several sizes/lengths and for various purposes, i.a. different locking rod lengths being used. Especially because the locking rod ends, which face the frame, preferably will be reinforced as a protection against burglary, it has so far been advantageous to produce complete and finished spagnolet mechanisms in the factory. However, a careful planning is then necessary for large series of windows and doors respectively and a risk-taking with large stocks, since the series may often be changed.

Spagnolet mechanisms with pivotable locking rods are also known. These mechanisms are also impaired by the above-mentioned drawbacks. The locking rod is mainly straight and can, in addition to a pivoting into said recess, also be removed from it in a straight direction, e.g. when the frame and the case are pried from each other. Also, the last-mentioned mechanisms must be assembled and finished in the factory, a protective plate, which functions as a joining shell and as a mounting base for the various components, being necessary and rendering the construction heavier, expensive materials being necessary, and rendering the whole mechanism more expensive, when it is made, assembled and mounted. The assembling is carried out as follows: Subsequent to the anchoring of the central adjusting mechanism with the locking rods on the shell the locking rods are mounted with mounting holes on a spindle, anchored in the shell and then the link, which in principle is U-shaped, is inserted with its legs into mounting holes in the locking bar and the locking rod end respectively. A U-shaped house is then mounted around this joining and is anchored in the shell through upsetting, which also holds for the spindle ends. Such a joining is not designed or suitable for a loosening, but will, if necessary, be replaced with a complete new spagnolet mechanism, in case parts must be replaced. Any changes afterwards, e.g. choosing shorter or longer locking rods and then also spagnolet mechanisms, is of course impossible.

### SUMMARY OF THE INVENTION

The object of the present invention is to counteract and as far as possible eliminate the above-mentioned drawbacks. Also, the invention will contribute to the development of the state of the art in this field in various additional respects.

These objects will be attained according to the invention by designing a locking device of the type set forth in the introduction, mainly in the way set forth in the characterizing clause of claim 1. Said objects are also attained by carrying out a method of the type set forth in the introduction, mainly in the way set forth in the characterizing clause of the first process claim.

### BRIEF DESCRIPTION OF THE DRAWINGS

Additional characterizing features and advantages of the invention are set forth in the following description, reference being made to the accompanying drawings, which show a few preferred but not limiting embodiments. The drawings show in detail in:

FIG. 1 a sectional planar view of a spagnolet, inserted in a window case and surrounded by a frame, with a locking device according to the invention;

FIG. 2 a view from the left in FIG. 1;

FIG. 3 a perspective view of a spagnolet with an adjusting mechanism and with locking devices according to the invention;

FIG. 4 a planar view of the spagnolet according to FIG. 3 with an adjusting mechanism, a locking rod, a frame lock and a locking plate according to the invention;

FIG. 5 a view from the right of the assembly according to FIG. 4;

FIG. 6 various views of a modified locking plate according to the invention;

FIG. 7 various views of a locking bolt according to the invention;

FIG. 8 various views of a connecting link according to the invention;

FIG. 9 a planar view and a side view of a locking rod according to the invention;

FIG. 10 sequential views of the assembling of a frame lock according to the invention; and

FIG. 11 various views of a frame lock according to the invention.

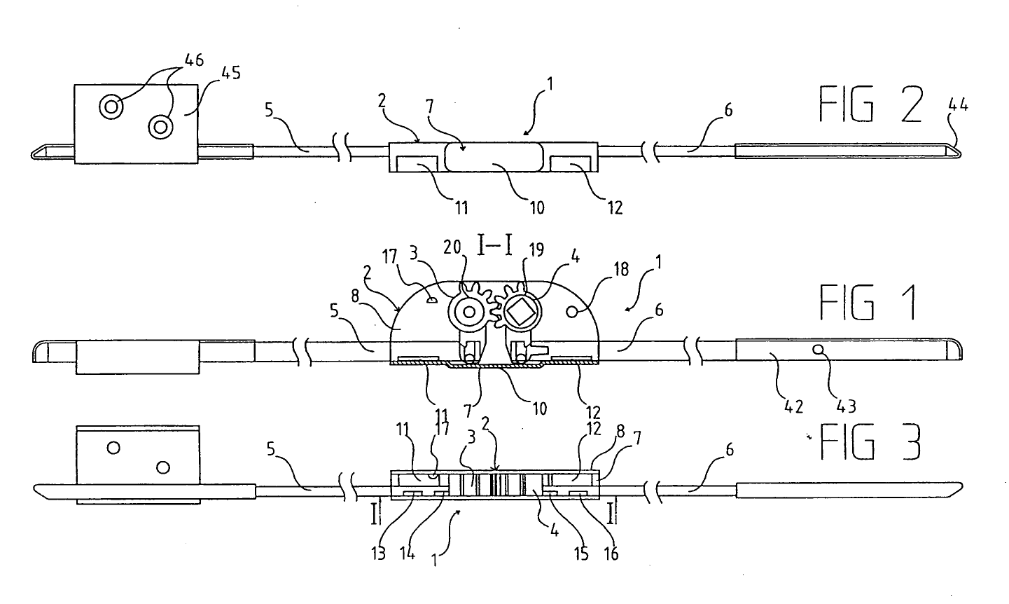

### DETAILED DESCRIPTION OF THE INVENTION

In the drawings a complete spagnolet 1 is shown, which includes a central adjusting mechanism 2, which includes a shell 3, comprising a doubly folded plate, between a web 4 and legs 5 of which, with a bulging 6 in one of the legs the inner ends of two in mutual opposite directions projecting locking rods 7 are guided, suitably designed as flat iron rods, and which are provided with a transverse notch 8, i.e. made in a wide side. In each notch a guide pin 9 meshes, associated with a driver 10, which with a spindle 11 is mounted in bearing bore 12 in legs 5. One of the spindles 11 is provided with a square hole 13, designed to receive a cone-shaped handle spindle (not shown). Thus, by turning the handle spindle one of said driver spindles and the driver itself are turned, which latter by means of a toothing 38 meshes with a matching toothing of second driver 10 and turns it around its spindle 10 in the opposite direction. In this way the two locking rods are simultaneously drawn into and are pushed out of respectively shell 3, which is provided with through holes 14, designed to allow a fastening in a door or window case 39, and a loosening and a locking respectively being obtained via the locking rods and by means of the spagnolet in relation to a frame 40, which surrounds said case.

The outer ends of the locking rods meshes each one with its frame lock 15, which is fastened in a recess 41 close to the frame in said case in its sides, which are facing the frame. The frame lock comprises a housing 16, made of a strong, bent plate material, roughly having a flat, elongated parallelepipedic shape, i.e. the house, which preferably consists of two symmetrical halves, has two wider main sides 17, which originate from a web 18, which extends roughly along half the length of the lock, within one of the narrow long sides 19, which has a hole 20 along its remaining portion. The other narrow long side 21 has a hole 22 opposite the web and is closed in the form of a bent web tongue 23 opposite hole 20. Gable side 24, adjacent web 18, is completely open, whereas gable side 25 roughly half of it is a hole 26, adjacent to said web tongues, and closed in the form of an end tongues 27, bent towards each other, originating from the main sides, as regards the other half of gable side 25, which preferably is transformed into said narrow long sides, designed as soft bends. Holes 20, 22 and 26 are limited by the attached bent portions 18, 23 and 27 by means of transverse notches 28, 29, 30, 31 and 32, which ensures, that the bendings will not affect the adjacent straight sections. Adjacent web 18 and hole 20 respectively the main sides are provided with crosswise through, preferably recessed bores 33 and 34 respectively, designed to receive screws or the like (not shown), anchored in the case. Also, a crosswise through bearing bore 35 is made in the corner area between gable side 24 and web 18. These three bores are mirror-symmetrically located, allowing the frame lock to be mounted in said recess with either main side 17. Finally, the main sides of the frame lock are provided with notch embossings 36, which extend along the length of the greater part of the frame lock and are closed at their ends but are open against the interior of the house and originate from that side of hole 26, which is adjacent the end tongues. These notch embossings run parallel to the web tongues and are visible from outside in the form of bulgings. They are designed to, with a limited insertion, receive the outer ends of the locking rods, which with their narrow sides are guided in the notch embossings and adjacent the end side are provided with a coupling hole 37, which runs straight through the sides and may be a round hole.

The frame lock includes also a locking bar 42 as well as a connecting link 43. The locking bar is designed to be connected to locking house 16 via a revolving spindle 44 and shares with the link a first joint 45, whereas the link is designed to, with a second joint 46, mesh with coupling hole 37 in the corresponding locking rod end. In a preferred embodiment revolving spindle 44 as well as joint 45 are located adjacent locking bar 42 in the form of one-sided spindle pins, which project in opposite directions and of which the one constituting revolving spindle 44 meshes with bearing bore 35, whereas said first joint 45 of link 43, mounted within the area of one end of the link, is designed as a bearing hole, running straight through and being designed to be pushed onto said second spindle pin 47 of the locking bar, which is a portion of said first joint. Said second joint 46 of the link, mounted at the second end of the link, is a hook, mounted transversely in relation to said bearing hole and which is designed to mesh with coupling hole 37 of the corresponding locking rod.

The locking bar preferably has a mainly triangular shape with rounded triangle ends, one triangle end mainly concentrically surrounding said revolving spindle 44, whereas another triangle end mainly concentrically surrounds the other joint, e.g. the spindle pin mounted on the other main side. Side 65, which connects said two triangle ends to each other, is fairly straight, whereas the other triangle side 66, originating from revolving spindle 44, suitably is bent outwards. The third triangle side includes a preferably U-shaped hook 67, a claw 60 being formed as a triangle point and a concentric rounding of the locking bar, which extends around the greater portion of the revolving spindle, i.e. about 200°.

Connecting link 43 can be half the thickness of the locking bar, since there is no risk, that e.g. during a burglary it is subjected to the same large stresses as the locking bar. The basic shape preferably is plate-like and between the two joints the link preferably is goose-necked to form two parts mutually displaced in parallel, joint 46 ending up in the centre plane of the locking bar. The portion with the last-mentioned joint has a hammer-like narrow shape, whereas the other link portion, starting from the other joint, will be continuously wider to optimize the guidance in house 3, a cavity 68 on the other side of the first joint allowing a pivoting of the link around the outer edge of web 18.

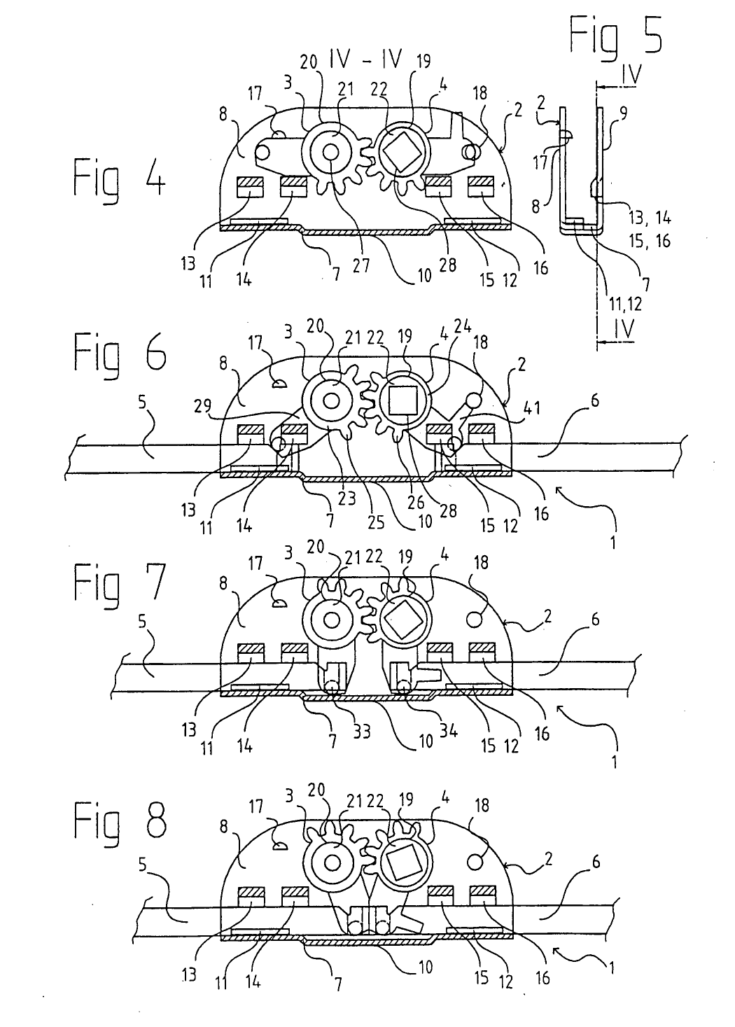

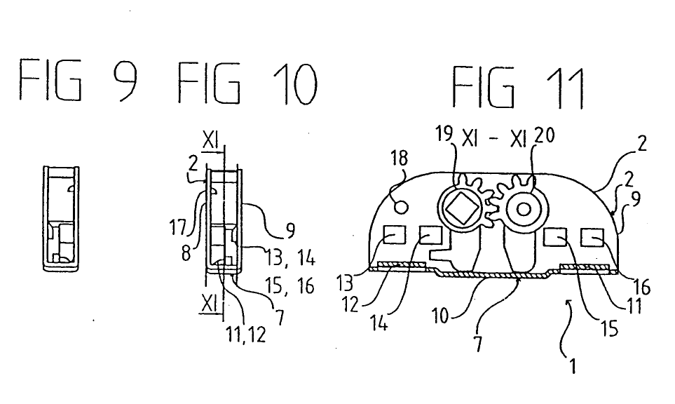

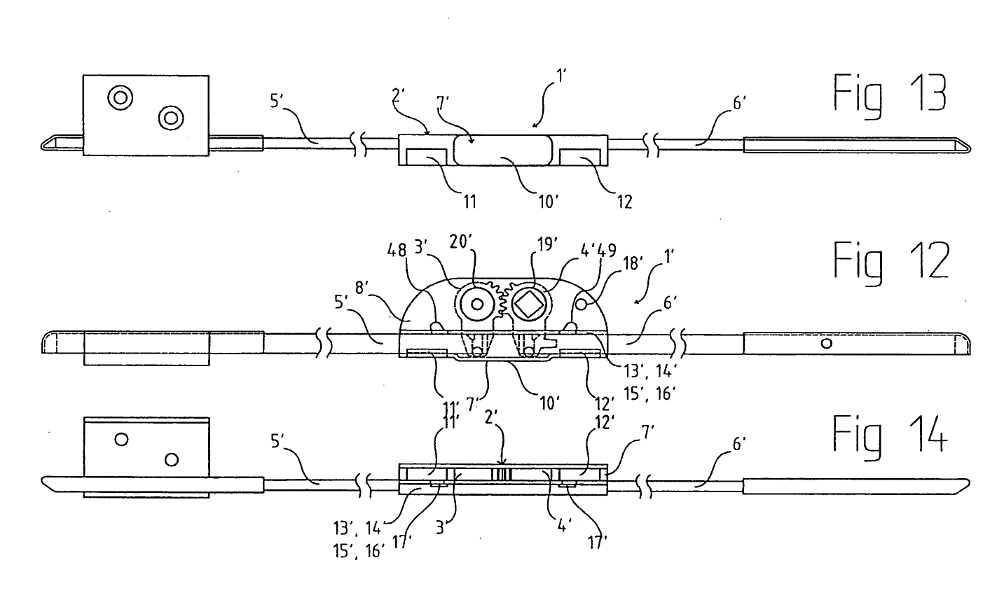

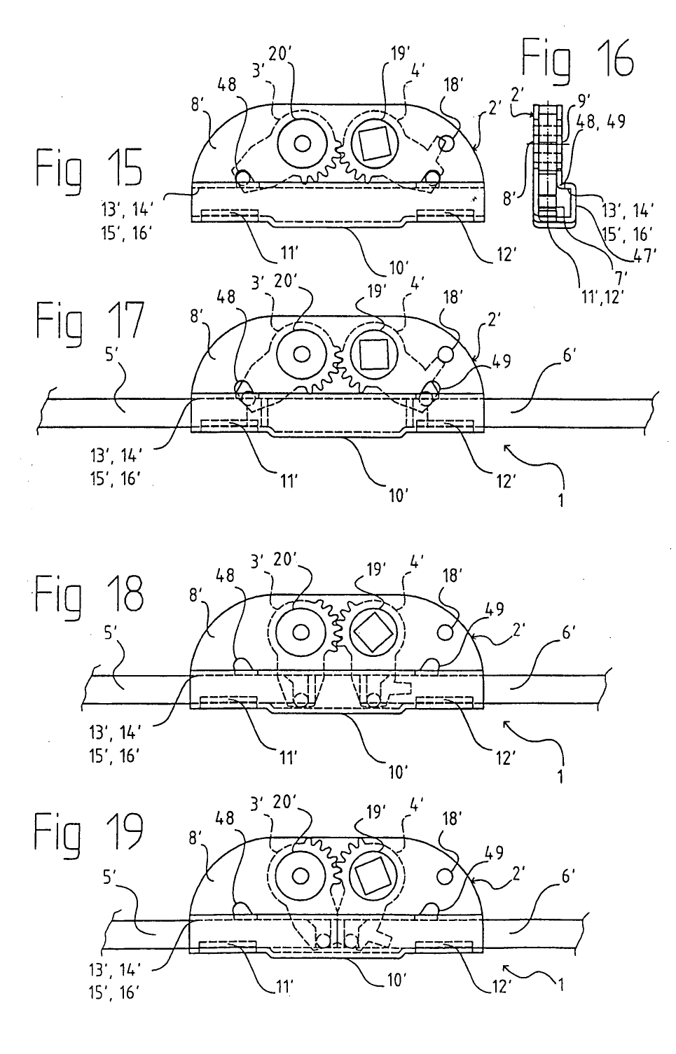

An arbitrary locking plate 49 can be used for the locking itself in a frame recess 48. It will be fastened, with screws (not shown), in the frame wood or the like. However, it is particularly advantageous to use a special locking plate according to the invention, which is shown in FIGS. 4 and 5. This locking plate has an enlongated parallelepipedic shape and is made of a strong bent plate. One of gable sides 51 is bevel-shaped jointly with side surfaces 50 and bottom side 69 and holds a hole 53, suitably recessed from the interior in order to easily insert a screw (not shown), which is inserted through a first locking hole 55 in upper or covering side 52, which has a locking flange 54, turned in the direction from the gable side 51 in connection with locking hole 55, for said locking bar 42. Upper side 52 has, towards the other gable side 58, a second locking hole 57, which ends immediately in front of gable side 58 to form a locking flange 59, designed to hook up the locking bar with its claw 60 in an alternative locking position. These two locking positions may be called a closing position and a ventilation position. In both positions the case and the frame cannot be pried open, since claw 60 from the rear or from the interior acts on the respective locking flange of the locking plate. Hole 57 is made by punching out material from the upper side and bending it to obtain an oblique fastening tongue 61, which is mainly parallel with the gable side and is provided with a suitably bevelled screw hole 62. The tongue is connected to the upper side on the side, which faces away from locking flange 59. A screw, not shown, is inserted into hole 57 and through screw hole 62 as well as through an e.g. oval hole 64 in the bottom side. In this way the locking plate will be fastened in the frame in a reliable way, entirely without visible screws and without screws accessible in a lateral direction. The upper side suitably will project laterally above the side surfaces and gable side 58 with a cover flange 56, in which holes, if necessary, for additional fastening screws can be made.

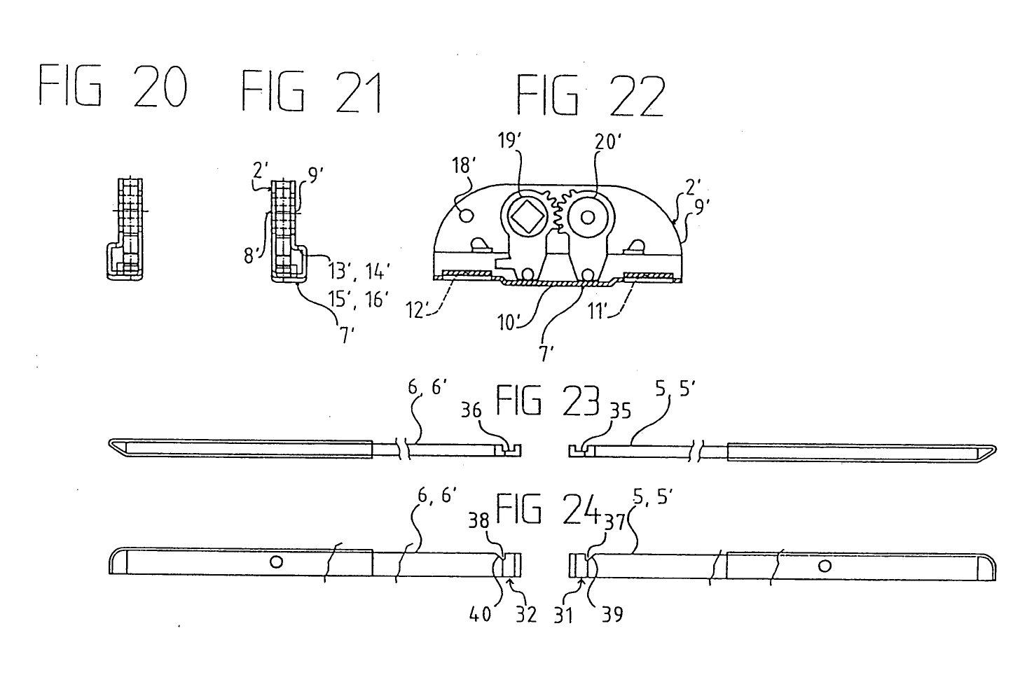

It is shown in FIG. 10, that on each side of the adjusting mechanism four parts are to be assembled as a unit, i.e. a locking rod, a frame locking house, a locking bar and a link. The locking bar and the link are initially joined to each other, according to FIG. 10b. The locking bar is then inserted into the house, the width of which is larger than the transverse extension of the locking bar and the lip of the revolving spindle but is smaller than the total transverse extension of the locking bar and the two spindle pins, which constitute the revolving spindle and the first joint for the link. This means, that only the unit, which comprises the locking bar and the link, can be inserted into the house, provided the link as a whole will stay outside the house. As soon as, according to FIG. 10c, said unit has been inserted into the house, the locking bar will be displaced in a lateral direction, according to FIG. 10d, the spindle pin then meshing with the bore in the house, designed for his purpose. Also, said locking rod with its coupling end will be pushed forward and up to the stop and into the notch embossings. Then the link, according to FIG. 10e, can be swung into the house, since the lateral displacement, mentioned above, has made room for the locking bar and also the pin for the first joint of the link. The link is then swung into the house completely, until its second joint is fastened in the hole of the guide hole. The locking rod is removed from the house again, according to FIG. 10f, the locking bar and the link following the locking rod and finally being completely withdrawn into the house. A joining, obtained in this way, can be secured by fastening a friction lock, e.g. designed as a simple U-shaped clip 63, to the locking rod adjacent the house, in order to prevent the locking rod from being pushed inwards again. When subsequently the spagnolet is inserted into a groove in the frame, then the friction lock suitably automatically engages the material, which surrounds the groove and is removed in this way. It is shown in FIGS. 10a-e, that the locking bar during the entire assembling process is in an end position, where the locking bar has been swung out of the house beyond the locking position, referred to, in relation to the locking plate. It is solely in this end position possible to let the link swing into and out of the house, due to the length and the position of the link in relation to the web tongues, In case the locking bar and then also the link is swung just slightly into the house, then the second end of the link ends up below the web tongues and is secured in this way against a swinging out-movement. Also in a transverse direction the locking bar and the link are secured in the house, because the inner width of the house is smaller than the total thickness of the locking bar and the two spindle pins, which project in different directions. In case it is necessary to replace a part, connected to the frame locking house, the fastening screws for the house in the frame have to be removed first and then an excessive turning can be done and the link and then the locking bar and the locking rods can be removed.

Whereas the insertion end of the locking rods in the adjusting mechanism suitably is finished by the manufacturer, their frame locking ends suitably can be cut by a user, e.g. a window factory, to a suitable length and be provided with link holes. In this way a user can buy a large amount of spagnolets with e.g. a maximum length and then be able to quickly and conveniently make them shorter according to the actual need the user has.

The invention is not limited to the embodiments described above and shown in the drawings but can be modified and supplemented in an arbitrary manner within the scope of the inventive idea and set forth in the following claims. Thus, house 16 and the other parts can of course be made according to other techniques and/or with other materials, e.g. plastic materials. The locking rods can, where appropriate, be combined with locking means, known per se, mounted along the length of the locking rods and implementing them in a lateral direction between two cases respectively. The locking bar and the link can be united, e.g. by riveting, before the mounting in the house. The locking bar can also, instead of its own stationary spindle, be provided with a straight through bore, into which a pin or the like is inserted straight through the house, to be used as a revolving spindle.

1-10. (canceled)

11. A locking device for a spagnolet mechanism (1), anchored in a door or window case (39), which comprises a central adjusting mechanism (2), from which locking rods (7) originate in mutually opposite directions, the free ends of which are designed to be anchored in recesses (41) in a frame (40), a locking bolt (42), pivotable by the locking rods at the frame around a stationary revolving spindle (44), being respon-sible, which bolt via a connecting link (43) with joints (45,46) at its ends in a locking house (16) is attached to the associated locking rod, characterized in that the locking bolt (42) is designed and displaced for a partial insertion into the locking house (16) and an anchoring there by means of said revolving spindle (44), and in that the locking bolt is designed to, in an extreme pivotal position, already be connected to or become connected to the connecting link (43) via its first joint (45) and to be pivoted into the locking house jointly with the connecting link, which in the locking house is designed to with its second joint (46) be connected to the corresponding locking rod end, which jointly with said adjusting mechanism (2) is designed to prevent the locking bolt (42) from pivoting back to said extreme position and in this way secure the unity of the coupling.

12. The locking device according to claim 11, wherein the outer ends of the locking rods (7) mesh with their respective frame lock (15), which is fastened in a recess (41), adjacent the frame, in said case (39), its sides facing the frame (40), and which comprises said house (16), which preferably consists of a strong, bent plate, roughly having the shape of a flat elongated paralleliped, said house, which comprises two at least mainly symmetrical halves, having two wider main sides (17), which originate from a web (18), which extends roughly along half the length of the frame lock (18) within one of the narrow longitudinal sides (19), which have a hole (20) along its remaining portion, and in that the other narrow longitudinal side (21) has a hole (22) opposite said web and is closed by means of the bent web tongues (23) opposite the first-mentioned hole (20), and in that the gable side (24), adjacent said web (18), is totally open, whereas roughly half of the other gable side (25) comprises a hole (26), adjacent said web tongues, and is closed by means of end tongues (27), bent towards each other and originating from the main sides regarding the other half of the gable side (25), which preferably is transformed into said narrow longitudinal sides in the form of soft roundings.

13. The locking device according to claim 12, wherein the holes (20,22 and 26) are delimited against the adjoining bent parts (18,23 and 27) by means of transverse notches (28,29,30,31 and 32) in order to ensure, that the bendings do not affect the adjacent straight sections, in that close to the web (18) and the hole (20), with a connection at the same level to the web (18), the main sides are provided with straight through, partly recessed bores (33 and 34 respectively), designed to receive screws or the like, to be anchored in the case, in that there is in the corner area between the totally open gable side (24) and the web (18) a straight through bearing bore (35), which three bores preferably are mirror-symmetrically placed, the frame lock being able to de disposed in said recess with either one of its main sides (17).

14. The locking device according to claim 13, wherein the main sides (17) and the frame lock (15) are provided with notch embossings (36), open towards the interior of the house, ending in a closed condition, extending over most of the length of the frame lock and originating from that side of the hole (26), which is adjacent the end tongues, in that said notch embossings run parallel to the web tongues and are visible from outside in the form of bulgings, and in that they are designed to receive, in a way, which limits the insertion, the outer ends of the locking rods (7), which with their narrow sides are guided in the notch embossings and in their ends, designed to be inserted into the frame lock, are provided with a coupling hole (37), which extends straight through the broad sides and which suitably is a round hole.

15. The locking device according to claim 11, wherein the revolving spindle (44) as well as the joint (45) are disposed at the locking bolt (42) in the form of one-sided spindle pins, which project in mutually opposite directions, of which the first one, the pin, which constitutes the revolving spindle, meshes with the bearing bore (35) of the frame lock house (16), whereas said first joint (45) of the link (43), disposed within the area for one end of the link, is designed as a straight through bearing bore, designed to be mounted on the second spindle tip (47) of the locking bolt, which constitutes a portion of said first joint, and in that the second joint (46) of the link, disposed at the other end of the link, has the form of a hook, disposed straight through said bearing bore, which is designed to mesh with the coupling hole (37) in the corresponding locking rod (7).

16. The locking device according to claim 11, wherein the locking rod (42) has a roughly triangular form with rounded triangular ends, one of the triangular ends roughly concentrically surrounding said revolving spindle (44), whereas the other triangular end roughly concentrically surrounds the other joint, e.g. the spindle pin, disposed on the other main side, in that the side (65), which connects said two triangular ends, suitably is straight, whereas the second triangular side (66), originating from the revolving spindle (44), suitably is bent outwards, and in that the third triangular side includes a preferably U-shaped hook (67), a claw (60) as a triangular point, being formed and a concentric rounding of the locking bolt, which extends around most of the revolving spindle, i.e. about 200°.

17. The locking device according to claim 11, wherein the connection link (43) preferably is only half as thick as the locking bolt (42), and in that its basic shape is plate-like and between the two joints is goose-necked in order to obtain two mutually displaced portions in parallel to each other, the second joint (46) ending up in the central plane of the locking bolt, which joint comprises a hammer-like narrow form, whereas the link portion, which is connected to the locking bolt, is originating from the above-mentioned continuously wider link portion to be able to optimize the guiding in the house (3), a cavity (68) on the other side of the first joint allowing the link to be pivoted around the outer edge of the web (18).

18. The locking device according to claim 11, wherein the locking plate (49) has the form of an elongated parallelepiped and preferably is made of a strong bent plate, in that one of the gable sides (51) is designed as a bevel jointly with side surfaces (50) and a bottom side (69) and houses a hole (53), suitably recessed from inside, to insert from inside a screw, which is designed to be easily inserted through a first locking hole (55) in an upper or cover side (52), which has in the direction from said gable side (51), in connection to the locking hole (55), a first locking flange (54) for said locking bolt (42) and which preferably has, in the direction towards the other gable side (58), a second locking hole (57), which ends immediately before last-mentioned gable side (58) in order to form a second locking flange (59), designed to fasten the looking bolt by means of a claw (60) in an alternative locking position.

19. The locking device according to claim 18, wherein the second locking hole (57) is obtained by punching out material from the cover side and bending it to obtain an oblique fastening tongue (61), roughly parallel to the oblique gable side, which is connected to the cover side on the side, which faces away from the second locking flange (59), in that a fastening screw is designed to be inserted through said second locking hole (57) and through the screw hole (62) as well as through an e.g. oval hole (64) in the bottom side in order to anchor the locking bolt in the frame without visible screws accessible from the side respectively, and in that the upper side suitably projects in a lateral direction along the side surfaces and the second gable side (58) with a cover flange (56) in order to possibly mount an additional fastening means.

20. The method of assembling a locking device at a spagnolet mechanism (1), which is designed to be anchored in a door or window case (39), according to claim 11, using a central adjusting mechanism (2) and locking rods (7), originating from it in mutually opposite directions, the free ends of which being anchored in recesses (41) in a frame (40), a locking bolt (42), pivotable by the locking rods around a stationary revolving spindle (44), being used for the locking, which locking bolt via a connection link (43) with joints (45,46), positioned at the ends, in a locking house (16), being connected to the associated locking rod, characterized in that at each side of the adjusting mechanism (2) four parts are assembled to a unit, i.e. a locking rod (7), a frame locking house (16), a locking bolt (42) and a connection link (43), initially the locking bolt and the link being attached to each other via a common joint (45), the locking bolt then being inserted into the frame locking house having a width larger than the transverse extension of the locking bolt and the length of the revolving spindle, projecting from it, but smaller than the total transverse extension of the locking bolt, the connection link and the length of said revolving spindle, allowing the unit consisting of the locking bolt and the link to be inserted into the house, only if the link in its entirety is held outside its locking bolt, inserted into the frame locking house, then being displaced in a transverse direction, the revolving spindle meshing with a bore (35), designed for this purpose, in the frame locking house, said locking rod then being pushed with its coupling end up to the stop into the inner notch embossings (36), the connection link (43) then being pivoted into the house, when said lateral displacement has made room for locking bolt including the first joint (45) of the link, the link then being entirely pivoted into the house, until its other joint (46) gets caught in a hole (37) in the guiding rod, the locking rod then being pulled out of the house, the locking bolt and the link following the locking rod and being drawn into the house and the joining, obtained in this way, preferably being secured by means of a friction lock (63) up to a placement in said window or door case (39).
